(19) United States
(12) Patent Application Publication
(10) Pub. No.: US 2026/0149214 A1
(43) Pub. Date: May 28, 2026

(54) CHARGING DOCK MODULE AND CHARGING DOCK

(71) Applicants: Tyco Electronics (Shanghai) Co., Ltd., Shanghai (CN); Tyco Electronics Technology (SIP) Co., Ltd., Suzhou (CN)

(72) Inventors: Hong (Vicky) Liu, Suzhou (CN); Renyi (Ronny) Dou, Suzhou (CN); Fangyue (Jason) Zhu, Shanghai (CN); Tiancheng Cao, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/402,026

(22) Filed: Nov. 26, 2025

(30) Foreign Application Priority Data
Nov. 26, 2024 (CN) 202411709380.6

(51) Int. Cl. H01R 13/424; H01R 13/52; H01R 13/66

(52) U.S. Cl. CPC H01R 13/424; H01R 13/5205; H01R 13/6683

(57) ABSTRACT

A charging dock module includes a housing, a terminal, a temperature sensor, a cable, a sealing adhesive, and a heat shrink tube. The housing has a cylindrical part. The terminal is inserted into a terminal insertion hole of the cylindrical part. The temperature sensor is provided in the terminal insertion hole and its lead wires are led out from the cylindrical part. The cable is electrically connected to the terminal and is led out from the cylindrical part. The adhesive is disposed around the cable and the lead wires, and is located outside the cylindrical part. The heat shrink tube is fitted and heat shrunk onto the sealing adhesive and the cylindrical part. The sealing adhesive and the heat shrink tube form a sealing assembly sealing between the cable and the housing, as well as between the lead wires and the housing.

### CROSS-REFERENCE TO RELATED APPLICATION

This application claims the benefit of the filing date under 35 U.S.C. § 119(a)-(d) of Chinese Patent Application No. 202411709380.6, filed on Nov. 26, 2024.

### FIELD OF THE INVENTION

The disclosure relates to a charging dock module and a charging dock comprising the charging dock module.

### BACKGROUND OF THE INVENTION

A charging dock commonly includes a housing, a terminal set in a terminal insertion hole of the housing, a high-voltage cable connected to the terminal, and a temperature sensor set in the terminal insertion hole of the housing. The temperature sensor is used to detect the temperature of the terminal. The high-voltage cable and the low-voltage lead wires of the temperature sensor are led out from a rear port of the terminal insertion hole of the housing.

In order to achieve sealing between the high-voltage cable and the housing, as well as between the low-voltage lead wires and the housing, it is usually necessary to install an elastic seal in the rear port of terminal insertion hole. The elastic seal has multiple through holes that allow the high-voltage cable and the low-voltage lead wires (also known as low-voltage cables) to pass through separately. However, the elastic seal is usually only suitable for sealing between a single cable and the housing, and is not suitable for sealing between multiple cables and the housing, which reduces the sealing effect.

### SUMMARY OF THE INVENTION

According to an embodiment of the present disclosure, a charging dock module includes a housing, a terminal, a temperature sensor, a cable, a sealing adhesive and a heat shrink tube. The housing has a cylindrical part and a terminal insertion hole formed in the cylindrical part. The terminal is inserted into the terminal insertion hole of the cylindrical part. The temperature sensor is provided in the terminal insertion hole and its lead wires are led out from a rear end of the cylindrical part. The cable is electrically connected to a rear end of the terminal and is led out from the rear end of the cylindrical part. The adhesive is wrapped around the cable, with the lead wires and located outside the rear end of the cylindrical part. The heat shrink tube is fitted and heat shrunk onto the sealing adhesive and the rear end of the cylindrical part. The sealing adhesive and the heat shrink tube form a sealing assembly sealing between the cable and the housing, as well as between the lead wires and the housing.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a charging dock according to an exemplary embodiment of the present invention;

FIG. 2 shows an illustrative exploded view of a charging dock according to an exemplary embodiment of the present invention;

FIG. 3 shows an exploded sectional view of a charging dock according to an exemplary embodiment of the present invention;

FIG. 4 shows a cross-sectional view of a charging dock module according to an exemplary embodiment of the present invention;

FIG. 5 shows an illustrative exploded view of a charging dock module according to an exemplary embodiment of the present invention;

FIG. 6 shows an exploded sectional view of a charging dock module according to an exemplary embodiment of the present invention;

FIG. 7 shows a plan sectional view of a charging dock module according to an exemplary embodiment of the present invention;

FIG. 8 shows an illustrative exploded view of the sealing assembly of a charging dock module according to an exemplary embodiment of the present invention; and

FIG. 9 shows another illustrative exploded view of the sealing assembly of the charging dock module according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

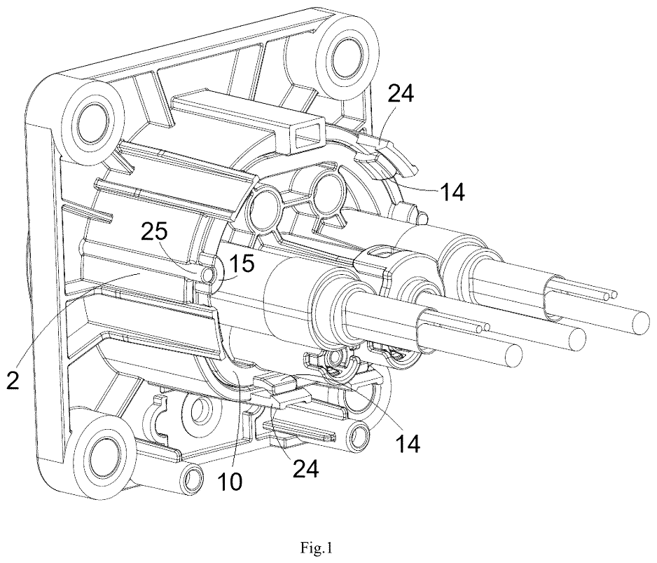

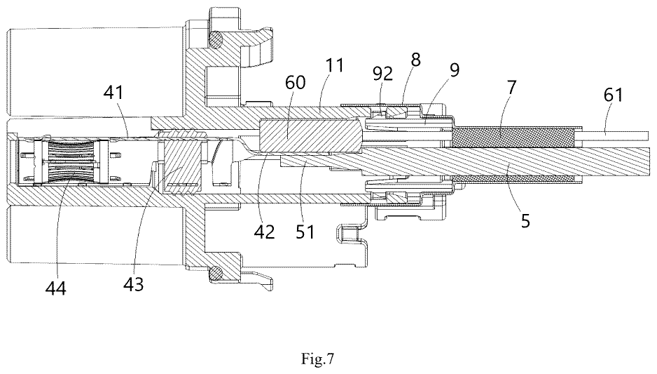

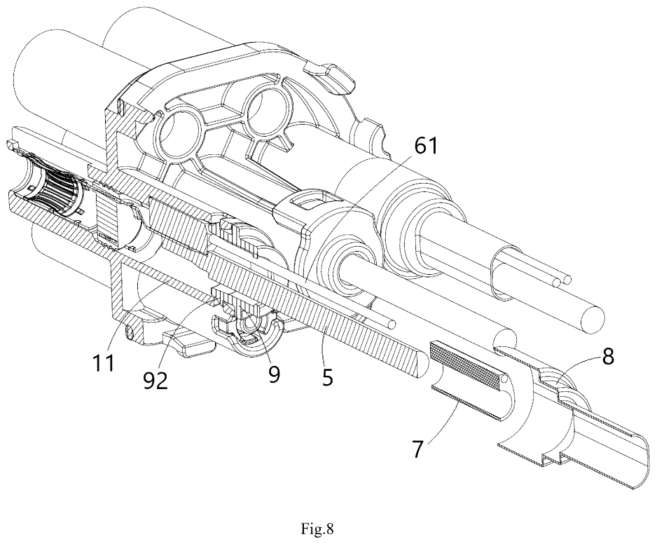

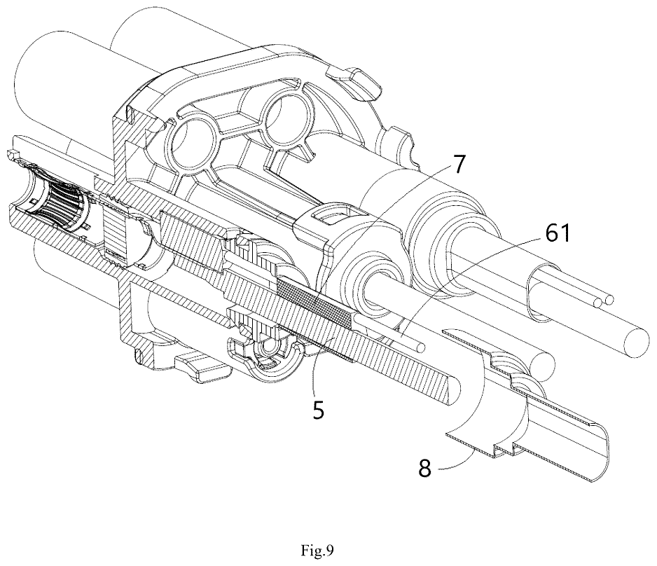

Referring generally to FIGS. 1-9, in an exemplary embodiment of the present disclosure, a charging dock module 100 is provided. The charging dock module 100 includes a housing 1, a terminal 4, a temperature sensor 6, a cable 5, anti-cement or sealing adhesive 7 and a heat shrink tube 8. The housing 1 has a cylindrical part 11 and a terminal insertion hole 101 formed in the cylindrical part 11. The terminal 4 is inserted into the terminal insertion hole 101 of the cylindrical part 11. The temperature sensor 6 is installed in terminal insertion hole 101 to detect the temperature of terminal 4. The lead wires 61 (also known as low-voltage cables) of temperature sensor 6 are led out from the rear end of cylindrical part 11. A cable 5 (also known as high voltage cable) is electrically connected to a rear end of terminal 4 and led out from a rear end of cylindrical part 11. Anti-cement 7 is wrapped around the cable 5 and lead wires 61 and is located outside the rear end of cylindrical part 11. The heat shrink tube 8 is fitted and heat shrunk onto the anti-cement 7 and the rear end of the cylindrical part 11. The anti-cement 7 and heat shrink tube 8 together form a sealing assembly for achieving sealing between the cable 5 and the housing 1, as well as between the lead wires 61 and the housing 1.

In the illustrated embodiment, the anti-cement 7 may be any type of sealing adhesive used in applications for sealing a cable 5, optionally with a heat shrink tube 8. In the illustrated embodiment, the cable 5 and two lead wires 61 of temperature sensor 6 are wrapped in anti-cement 7, and the cable 5 is separated from the two lead wires 61 by the anti-cement 7.

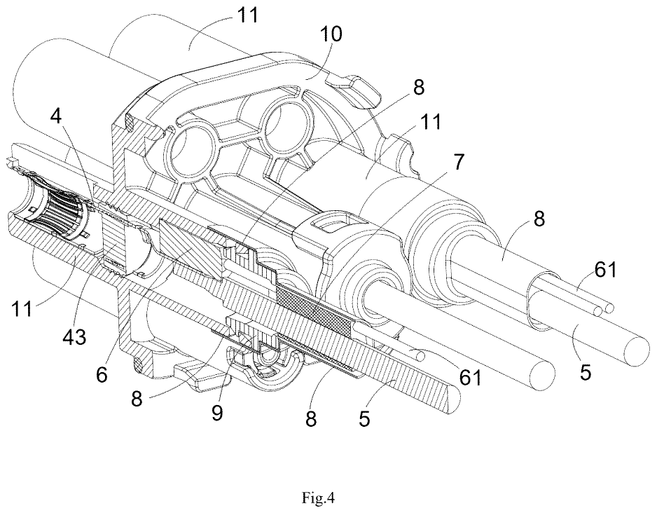

The charging dock module 100 further includes a rear end cover 9 installed into a rear port of the terminal insertion hole 101 and fixed to the rear end of the cylindrical part 11, as shown in FIG. 4. The rear end cover 9 has a through-hole that allows the cable 5 and the lead wires 61 to pass through. The rear end cover 9 is wrapped in the heat shrink tube 8, and the anti-cement 7 is located outside the rear end cover 9.

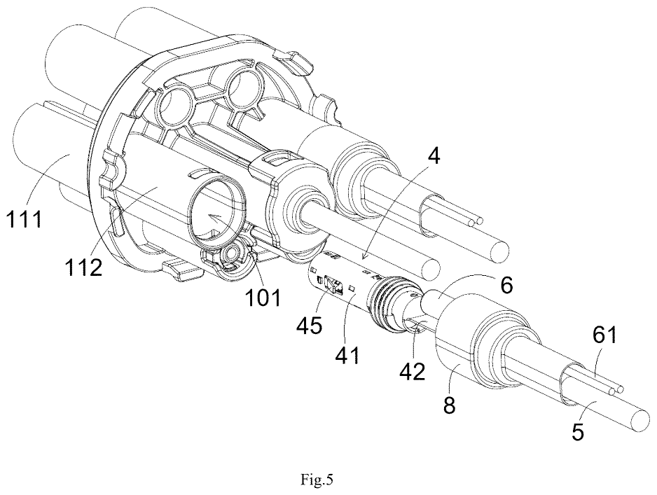

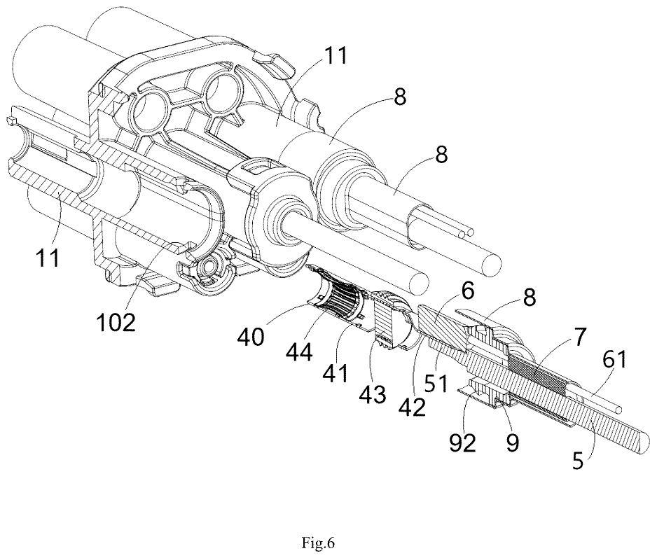

The rear end cover 9 has multiple elastic buckles 92 inserted into the rear port of the terminal insertion hole 101, as shown in FIGS. 5 and 6. Multiple snap slots 102 are formed on the peripheral wall of the rear end of the cylindrical part 11. The multiple elastic buckles 92 are respectively engaged with the multiple snap slots 102 to fix the rear end cover 9 to the rear end of the cylindrical part 11.

The terminal 4 includes a terminal body 40, which has a cylindrical part 41 and a welding part 42 connected to the rear end of the cylindrical part 41, as shown in FIG. 6. The main body 60 of temperature sensor 6 is in thermal contact with the welding part 42 of terminal 4, and is adapted to detect the temperature of the terminal 4. One end 51 of cable 5 is welded to the welding part 42 of terminal 4. The welding part 42 of terminal 4 is flat and has two opposite sides in its thickness direction. One end 51 of cable 5 is welded to one side of the welding part 42 of terminal 4, and the main body 60 of temperature sensor 6 is in thermal contact with the other side of the welding part 42 of terminal 4.

The terminal 4 further includes an elastic contact component 44, which is inserted into the front of the cylindrical part 41 of terminal 4 to make electrical contact with an inserted mating terminal. In one embodiment, the terminal body 40 and the elastic contact component 44 are integral stamped parts, respectively. The terminal 4 further includes a sealing element 43, which is injection molded onto the cylindrical part 41 of the terminal 4 and enters the inner cavity of the cylindrical part 41 through an opening on the cylindrical part 41. The sealing element 43 is used to seal the inner cavity of the cylindrical part 41 of terminal 4 and the terminal insertion hole 101 of the housing 1. A locking spring 45 is formed on the cylindrical part 41 of the terminal 4, and the locking spring 45 is engaged with the inner wall of the terminal insertion hole 101 to lock the terminal 4 in the terminal insertion hole 101.

As shown in FIGS. 4 and 5, the housing 1 has multiple cylindrical parts 11 and multiple terminal insertion holes 101 respectively formed in the multiple cylindrical parts 11. The charging dock module 100 includes multiple terminals 4 respectively inserted into multiple terminal insertion holes 101, multiple cables 5 respectively connected to the multiple terminals 4, and multiple temperature sensors 6 respectively set in the multiple terminal insertion holes 101. The charging dock module 100 includes multiple sealing assemblies respectively set to the rear ends of multiple cylindrical parts 11, and are adapted to achieve sealing between multiple cables 5 and the housing 1, as well as between the lead wires 61 of multiple temperature sensors 6 and the housing 1.

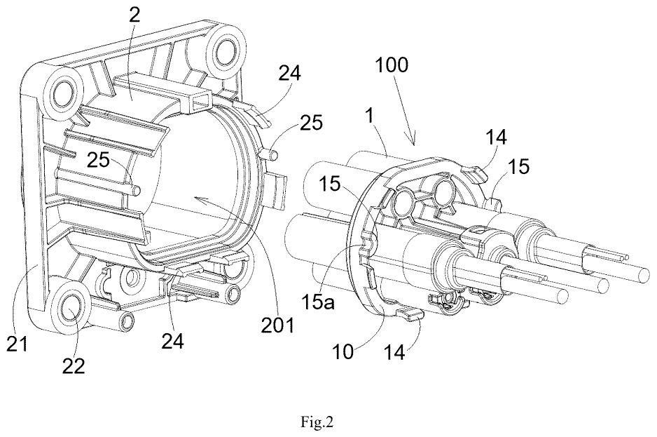

In the illustrated embodiment, as shown in FIG. 2, the housing 1 further comprises a cover plate part 10, adapted to cover the rear port of the inner cavity 201 of the installation seat 2 of the charging dock. The cylindrical part 11 includes a front column part 111 and a rear column part 112 located on the front and rear sides of the cover plate part 10, respectively. The front column part 111 is adapted to be inserted into the inner cavity 201 of the installation seat 2.

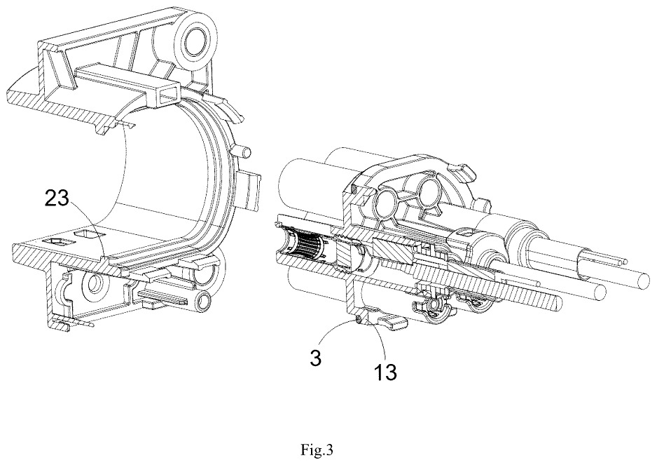

The charging dock module 100 further includes a sealing ring 3 fitted onto the cover plate part 10, as shown in FIG. 3. A first flange 13 is formed on the cover plate part 10. The first flange 13 is axially pressed against the rear side of the sealing ring 3. The sealing ring 3 is suitable for being axially compressed between the first flange 13 and a second flange 23 inside the installation seat 2 to achieve sealing between the installation seat 2 and the housing 1.

Multiple first elastic claws 14 are formed on the rear side of the cover plate part 10, as shown in FIGS. 1 and 2, which are distributed at intervals in the circumferential direction of the cover plate part 10. The multiple first elastic claws 14 are used to engage with multiple second elastic claws 24 on the rear end of the installation seat 2 to lock the housing 1 in the installation seat 2. Multiple positioning parts 15 are formed on the rear side of the cover plate part 10, which are distributed at intervals in the circumferential direction of the cover plate part 10. The positioning parts 15 have positioning slots 15a suitable for engaging with the positioning posts 25 on the rear end surface of the installation seat 2 to position the cover plate part 10 in the circumferential direction.

In another exemplary embodiment of the present disclosure, a charging dock is also disclosed. The charging dock includes an installation seat 2 and a charging dock module 100. The installation seat 2 is formed with an inner cavity 201. The charging dock module 100 is inserted into the inner cavity 201 of the installation seat 2. In the illustrated embodiment, as shown in FIG. 3, a second flange 23 is formed in the inner cavity 201 of the installation seat 2, which is axially opposite to the first flange 13 on the cover plate part 10 of the housing 1. The sealing ring 3 on the housing 1 is axially compressed between the first flange 13 and the second flange 23 to achieve sealing between the installation seat 2 and the housing 1.

Multiple second elastic claws 24 are formed on the rear end of the installation seat 2. The multiple second elastic claws 24 are distributed at intervals in the circumferential direction of the installation seat 2. The multiple second elastic claws 24 are respectively engaged with the multiple first elastic claws 14 on the rear side of the cover plate part 10 to lock the housing 1 in the installation seat 2, as shown in FIG. 1.

Multiple positioning posts 25, shown in FIG. 2, are formed on the rear end face of the installation seat 2. The multiple positioning posts 25 are distributed at intervals in the circumferential direction of the installation seat 2. The multiple positioning posts 25 are respectively engaged with the positioning slots 15a of the multiple positioning parts 15 on the cover plate part 10 to position the cover plate part 10 in the circumferential direction.

The installation seat 2 has a flange part 21, as shown in FIG. 2. A connection hole 22 is formed in the flange part 21 to allow a threaded connection member to pass through. In this way, the flange part 21 can be fastened to a mounting panel (e.g., vehicle body sheet metal) through the threaded connection member passing through the connection hole 22.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A charging dock module, comprising:
a housing having a cylindrical part and a terminal insertion hole formed in the cylindrical part;
a terminal inserted into the terminal insertion hole of the cylindrical part;
a temperature sensor arranged in the terminal insertion hole and having a plurality of lead wires extending from a rear end of the cylindrical part;
a cable electrically connected to a rear end of the terminal and extending from the rear end of the cylindrical part;
a sealing adhesive provided around the cable and the lead wires and located outside the rear end of the cylindrical part; and
a heat shrink tube fitted and shrunk onto the sealing adhesive and the rear end of the cylindrical part, the sealing adhesive and the heat shrink tube together forming a sealing assembly creating a seal between the cable and the housing and between the lead wires and the housing.

2. The charging dock module according to claim 1, wherein the cable and a pair of lead wires of the plurality of lead wires of the temperature sensor are wrapped in, and separated by, the sealing adhesive.

3. The charging dock module according to claim 1, further comprising a rear end cover installed into a rear port of the terminal insertion hole and fixed to the rear end of the cylindrical part, the rear end cover having a through-hole receiving the cable and the lead wires therethrough, the rear end cover is wrapped in the heat shrink tube, and the sealing adhesive is located outside the rear end cover.

4. The charging dock module according to claim 3, wherein the rear end cover includes a plurality of elastic buckles inserted into the rear port of the terminal insertion hole, a plurality of snap slots are formed on a peripheral wall of the rear end of the cylindrical part, the elastic buckles are respectively engaged with the snap slots to fix the rear end cover to the rear end of the cylindrical part.

5. The charging dock module according to claim 1, wherein:
the terminal includes a terminal body having a cylindrical part and a welding part connected to a rear end of the cylindrical part of the terminal body;
a main body of the temperature sensor is in thermal contact with the welding part of the terminal and detects a temperature of the terminal; and
an end of the cable is welded to the welding part of the terminal.

6. The charging dock module according to claim 5, wherein the welding part of the terminal is flat and defines a pair of opposite sides in a thickness direction, the end of the cable is welded to one of the pair of sides of the welding part of the terminal, the main body of the temperature sensor is in thermal contact with the other of the pair of sides of the welding part of the terminal.

7. The charging dock module according to claim 5, wherein the terminal has an elastic contact component inserted into a front part of the cylindrical part of the terminal and adapted to electrically contact an inserted mating terminal.

8. The charging dock module according to claim 5, wherein the terminal has a sealing element injection molded onto the cylindrical part of the terminal and received within an inner cavity of the cylindrical part through an opening on the cylindrical part, the sealing element seals the inner cavity of the cylindrical part of the terminal and the terminal insertion hole of the housing.

9. The charging dock module according to claim 5, wherein a locking spring is formed on the cylindrical part of the terminal and is engaged with an inner wall of the terminal insertion hole to lock the terminal in the terminal insertion hole.

10. The charging dock module according to claim 1, wherein:
the cylindrical part is one of a plurality of cylindrical parts of the housing and the terminal insertion hole is one of a plurality of terminal insertion holes respectively formed in the cylindrical parts;
the terminal is one of a plurality of terminals respectively inserted into the terminal insertion holes, the cable is one of a plurality of cables respectively connected to the terminals, and the temperature sensor is one of a plurality of temperature sensors respectively set in the terminal insertion holes; and
the charging dock module includes a plurality of sealing assemblies respectively arranged at a plurality of rear ends of the cylindrical parts, the sealing assemblies seal between the cables and the housing and between the lead wires of the temperature sensors and the housing.

11. The charging dock module according to claim 1, wherein the housing has a cover plate part covering a rear port of an inner cavity of an installation seat of a charging dock, the cylindrical part has a front column part and a rear column part located on a front side and a rear side of the cover plate part, respectively, the front column part is inserted into the inner cavity of the installation seat.

12. The charging dock module according to claim 11, further comprising a sealing ring fitted onto the cover plate part, a first flange is formed on the cover plate part and axially pressed against a rear side of the sealing ring, the sealing ring is axially compressed between the first flange and a second flange inside the installation seat to provide a seal between the installation seat and the housing.

13. The charging dock module according to claim 11, wherein a plurality of first elastic claws are formed on the rear side of the cover plate part and are distributed at intervals in a circumferential direction of the cover plate part, the first elastic claws engage with a plurality of second elastic claws on a rear end of the installation seat to lock the housing in the installation seat.

14. The charging dock module according to claim 11, wherein a plurality of positioning parts are formed on the rear side of the cover plate part and distributed at intervals in a circumferential direction of the cover plate part, the positioning parts include a plurality of positioning slots suitable for respectively engaging with a plurality of positioning posts on a rear end surface of the installation seat to position the cover plate part in the circumferential direction.

15. A charging dock, comprising
an installation seat formed with an inner cavity; and
a charging dock module inserted into the inner cavity of the installation seat, including:
a housing having a cylindrical part and a terminal insertion hole formed in the cylindrical part;
a terminal inserted into the terminal insertion hole of the cylindrical part;
a temperature sensor arranged in the terminal insertion hole and having a plurality of lead wires extending from a rear end of the cylindrical part;
a cable electrically connected to a rear end of the terminal and extending from the rear end of the cylindrical part;
a sealing adhesive provided around the cable and the lead wires and located outside the rear end of the cylindrical part; and
a heat shrink tube fitted and shrunk onto the sealing adhesive and the rear end of the cylindrical part, the sealing adhesive and the heat shrink tube together forming a sealing assembly creating a seal between the cable and the housing and between the lead wires and the housing.

16. The charging dock according to claim 15, wherein the housing has a cover plate part covering a rear port of the inner cavity of the installation seat.

17. The charging dock according to claim 16, further comprising a sealing ring fitted onto the cover plate part, a first flange is formed on the cover plate part and is axially pressed against a rear side of the sealing ring.

18. The charging dock according to claim 17, wherein a second flange axially opposite to the first flange on the cover plate part of the housing is formed in the inner cavity of the installation seat, and the sealing ring on the housing is axially compressed between the first flange and the second flange to achieve sealing between the installation seat and the housing.

19. The charging dock according to claim 16, wherein a plurality of second elastic claws are formed on a rear end of the installation seat, the second elastic claws are distributed at intervals in a circumferential direction of the installation seat, the second elastic claws are respectively engaged with a plurality of first elastic claws on a rear side of the cover plate part to lock the housing in the installation seat.

20. The charging dock according to claim 15, wherein the installation seat has a flange part, and a connection hole is formed in the flange part to allow a threaded connection member to pass through.
